(19) United States
(12) Patent Application Publication
(10) Pub. No.: US 2016/0368406 A1
(43) Pub. Date: Dec. 22, 2016

(54) BACKREST STRUCTURE FOR A VEHICLE SEAT, AND VEHICLE SEAT

(71) Applicant: Johnson Controls Components GmbH & Co. KG, Kaiserslautern (DE)

(72) Inventors: Wolfgang PLUTA, Heiligenmoschel (DE); Heinrich HAMMANN, Teschenmoschel (DE); Thomas DILL, Heiligenmoschel (DE); Christian WOLF, Katzenbach (DE)

(21) Appl. No.: 14/901,795

(22) PCT Filed: Jul. 11, 2014
(86) PCT No.: PCT/EP2014/064895

§ 371 Date: Dec. 29, 2015

(30) Foreign Application Priority Data
Jul. 17, 2013 (DE) 10 2013 213 995.0

(51) Int. Cl. B60N 2/68; B60N 2/72; B60N 2/64

(52) U.S. Cl. CPC B60N 2/686; B60N 2/682; B60N 2/64; B60N 2/72

(57) ABSTRACT

A backrest structure for a vehicle seat (1) includes a flat base sheet (30) and another structural part (20, 40) which are connected to each other by at least one laser weld seam (50) using a laser welding procedure. In a process, at least one tongue (28, 36, 38) of the base sheet (30) is bent by 180 DEG in the region of the weld seam (50) and placed on the remaining base sheet (30). The at least one weld seam (50) connects the bent tongues (28, 36, 38), the remaining base sheet (30), and the other structural part (20, 40) to one another. A vehicle seat (1) is also provided with such a backrest.

### CROSS REFERENCE TO RELATED APPLICATIONS

This application is a United States National Phase Application of International Application PCT/EP2014/064895 filed Jul. 11, 2014 and claims the benefit of priority under 35 U.S.C. §119 of German Patent Application 10 2013 213 995.0 filed Jul. 17, 2013, the entire contents of which are incorporated herein by reference.

### FIELD OF THE INVENTION

The invention relates to a backrest structure for a vehicle seat having a planar base sheet and an additional structural component which are connected to each other by means of laser welding using at least one weld seam, and a vehicle seat having at least one such backrest structure.

### BACKGROUND OF THE INVENTION

DE 10 2005 005 485 A1 discloses a backrest structure for a backrest of a vehicle seat having at least one base sheet and a backrest frame comprising a left and a right vertically extending lateral top-hat profile-member and an upper and a lower top-hat profile-member which extends in the transverse direction. The top-hat profile-members are welded to the front side of the base sheet. The lateral top-hat profile-members are welded to the top-hat profile-members which extend in the transverse direction.

DE 10 2006 000 850 B4 discloses a backrest structure having an integrally constructed, substantially peripheral frame. The frame extends at three edge regions of the base sheet and comprises two longitudinal portions which extend in a parallel manner and a transverse portion which connects the longitudinal portions. In order to increase the rigidity, the base sheet has reinforcement beads. In order to fix and secure a cushion, upholstery suspension channels are provided on the outer edge regions of the base sheet.

DE 10 2010 054 185 A1 discloses a backrest having a frame which is constructed in several portions. The frame comprises two longitudinal struts which extend in a parallel manner along the lateral edge regions of the base sheet. A transverse strut is arranged along the upper edge region. In order to reinforce the base sheet, bead-like channels are impressed.

DE 10 2005 001 606 B4 discloses a backrest structure having an integrally constructed frame sheet which extends over a large portion of the surface of the base sheet. The frame sheet and the base sheet are connected to each other by means of laser welding. In this instance, a laser beam penetrates the base sheet and the surface of the frame sheet, whereby a weld seam which welds the base sheet to the frame sheet is produced.

DE 35 15 598 C2 discloses a weld connection of two thin metal sheets which form an inner and an outer sheet, for example, an inner and an outer sheet for doors and/or hatches in motor vehicles, wherein the outer sheet (2) forms a visually smooth outer face and is flanged in the edge region thereof. The outer sheet is flanged through 180° on the rear face thereof, and the inner sheet is placed with an edge region on the flanged edge of the outer sheet. The connection between this sheet and the flanged edge is carried out by means of a laser beam from the side facing away from the outer face.

Base sheets having a material thickness of 0.6 mm and more are generally used in the production of backrest structures. The trend in vehicle seat development is toward lightweight construction. Large sheet components, such as base sheets of backrest structures, have a very high weight proportion of the overall backrest. As a result of the large surface areas of the base sheets, a large amount of material is provided, which results in the high weight. Since the surface-areas of the sheet components cannot be reduced, with a predetermined material, for example, sheet steel, only the sheet thickness of the sheets can be reduced in order to save weight. Thus, the sheet thickness of large sheet components has in the past been continuously reduced. Below a sheet thickness of approximately 0.6 mm, however, weldability of the sheets is no longer ensured in a simple manner since too little material is available. As a result of the small material thickness, there is the risk during the welding process that the laser beam may burn a hole in the base sheet, whereby the sheet becomes damaged and is not welded to the frame. Adapters cannot readily be fitted to the thin sheets. The sheets which are becoming increasingly thin additionally involve an increased risk of injury during handling and further processing.

### SUMMARY OF THE INVENTION

An object of the invention is to provide a backrest structure for a vehicle seat having a relatively thin base sheet and thereby reduced weight and a vehicle seat having reduced weight.

A backrest structure of the generic type comprises a planar base sheet and an additional structural component which are connected to each other by means of laser welding using at least one weld seam. The term “planar” is intended in particular to be understood to mean substantially flat. However, individual geometries such as reinforcement beads require a deviation from an absolutely flat shape. The term “weld seam” is also intended to be understood to refer to weld seams whose length substantially corresponds to the width. Consequently, weld seams also include weld spots.

According to the invention, there is provision in the region of the at least one weld seam for at least one tongue of the base sheet to be bent through 180° and placed on the remaining base sheet, and for the at least one weld seam to connect the bent tongue, the remaining base sheet and the additional structural component to each other. Consequently, the weld seam extends over the bent part-region, the remaining base sheet and the additional structural component.

As a result of the bending of the at least one tongue of the base sheet, a doubled material thickness of the base sheet is produced locally. As a result of the doubled material thickness, a weld seam can be produced in a simplified manner by means of laser welding. The risk that the laser beam may burn a hole in the base sheet is reduced. Also, any air gap which may remain between the base sheet and the tongue does not influence the laser welding operation or has only an insignificant influence. Consequently, a relatively thin base sheet with reduced weight can be used, whereby the vehicle seat also has a reduced weight. Furthermore, the production costs are reduced and the efficiency is thereby increased.

According to an advantageous development of the invention, the at least one tongue is bent multiple times through 180° and placed on the remaining base sheet. The material thickness of the base sheet is thereby not only doubled but multiplied. As a result of the multiplied material thickness of the base sheet, a weld seam can be produced in an even more simplified manner by means of laser welding.

An advantageous saving of weight is achieved when the base sheet has a material thickness of less than 0.5 mm. Preferably, the base sheet has a material thickness between 0.3 mm and 0.5 mm, in a particularly preferred manner of approximately 0.35 mm. This material thickness brings about an advantageous saving of weight and nonetheless enables safe production of a weld seam by means of laser welding.

According to a preferred embodiment of the invention, the additional structural component is a backrest frame.

The rigidity of the backrest structure can be increased by a plurality of bent tongues being arranged along an outer contour of the base sheet and being welded to the backrest frame. The spacings between individual tongues may be equidistant. However, the spacings between individual tongues may also be adapted to the loading of the backrest structure.

According to an advantageous embodiment, the bent tongue is a rectangular tongue which is separated at three sides from the remaining base sheet and which is bent through 180° at the fourth side which is connected to the remaining base sheet and placed on the remaining base sheet. Such a tongue can be produced in a relatively simple manner by means of punching from the base sheet at any location.

According to another advantageous embodiment, the bent part-region is edge material which is located at the edge of the base sheet and which is in particular tongue-like. The punching operation can thereby be dispensed with and there is locally produced a relatively large securing region which is located at the edge of the base sheet.

The base sheet may have at least one securing location which is inwardly spaced apart from the outer contour thereof. This may be supplemented by a securing region in the region of the outer contour of the base sheet. It is thus possible, for example, for backrest frames, which are provided as a top-hat profile-member with two securing flanges which extend in a parallel manner, to be secured to the base sheet. Preferably, the securing locations each comprise a passage region and a tongue.

If the edge material is simply bent through 180°, there is produced a flat edge contour, which does not have a sharp-edged but instead a rounded edge region. The risk of injury when a backrest structure is produced is thereby reduced.

If the edge material is bent several times, wherein the edge material and the remaining base sheet enclose a geometric shape, a contoured edge contour is produced. The contoured edge contour also reduces the risk of injury since it does not have a sharp-edged, but instead a rounded edge region. In addition, the contoured edge contour increases the rigidity of the base sheet.

According to an advantageous development of the invention, the backrest frame has an upholstery suspension channel for securing a cushion. It is consequently not necessary to provide an upholstery suspension channel on the base sheet and, consequently, the base sheet does not need to absorb the load resulting from the tension of the cushion and, consequently, a base sheet having a relatively thin material thickness can be used.

According to another development of the invention, the base sheet additionally has an upholstery suspension region which is preferably integrated in the upholstery suspension channel of the backrest frame in a positive-locking manner. The rigidity of the upholstery suspension channel is thereby increased.

The rigidity of the upholstery suspension channel is increased even further when the base sheet is doubled in the region of the upholstery suspension region.

The rigidity of the base sheet can be increased by means of at least one reinforcement bead. Preferably, the base sheet is produced from sheet steel or sheet aluminum.

According to another preferred embodiment of the invention, the additional structural component is a wire, in particular a Top Tether clip of an Isofix child seat securing system.

The object is also achieved with a vehicle seat which comprises at least one backrest structure according to the invention.

The invention is explained in greater detail below with reference to advantageous embodiments illustrated in the figures. However, the invention is not limited to these embodiments. The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

In the drawings:

FIG. 1 is a schematic, partially sectioned view of a vehicle seat;

FIG. 2 is a perspective view of a backrest structure of the vehicle seat according to FIG. 1 according to a first embodiment;

FIG. 3 is a view of a base sheet of the backrest structure according to FIG. 2;

FIG. 4 is an enlarged illustration of the marked part-region of the base sheet according to FIG. 3;

FIG. 5 is a sectional view taken along the line A-A from FIG. 4, wherein a portion of the frame is additionally illustrated;

FIG. 6 is a view of a backrest structure of the vehicle seat according to FIG. 1 according to a second embodiment, when viewed in the travel direction;

FIG. 7 is a sectional view taken along the line B-B from FIG. 6;

FIG. 8 is a sectional view through a securing region of a base sheet according to a first configuration of the second embodiment;

FIG. 9 is a sectional view through a securing region of a base sheet according to a second configuration of the second embodiment;

FIG. 10 is a perspective view of a backrest structure of the vehicle seat according to FIG. 1 according to a third embodiment with a Top Tether clip; and

FIG. 11 is a sectional view taken along line C-C from FIG. 10.

### DESCRIPTION OF THE PREFERRED EMBODIMENTS

A vehicle seat 1 for a motor vehicle, in this instance a rear seat, has a seat member 3 and a backrest 4 which is fitted thereto and which can be adjusted in terms of inclination. However, the vehicle seat 1 could also be a front seat. The backrest 4 comprises a backrest frame 40 and a base sheet 30, which is constructed as a planar object. The backrest frame 40 and the base sheet 30 together form a backrest structure by being welded together, preferably by means of laser welding.

The base sheet 30 has in this instance a material thickness of approximately 0.35 mm. The base sheet 30 contains in this instance reinforcement ribs and reinforcement beads 31 and is nonetheless intended to be considered to be planar. In this instance, the backrest frame 40 has a material thickness of approximately 1.5 mm. Other material thicknesses of the backrest frame 40 are also conceivable, in particular between 0.8 mm and 4 mm.

The arrangement of the vehicle seat 1 inside the vehicle and the conventional travel direction thereof define the directional indications used below. In this instance, a direction which is orientated perpendicularly to the ground is referred to below as the vertical direction and a direction perpendicular to the vertical direction and perpendicular to the travel direction is referred to below as the transverse direction. The vertical direction also includes an angular range relative to the direction which is orientated perpendicularly to the ground, in which range the backrest 4 is located in the conventional position for use.

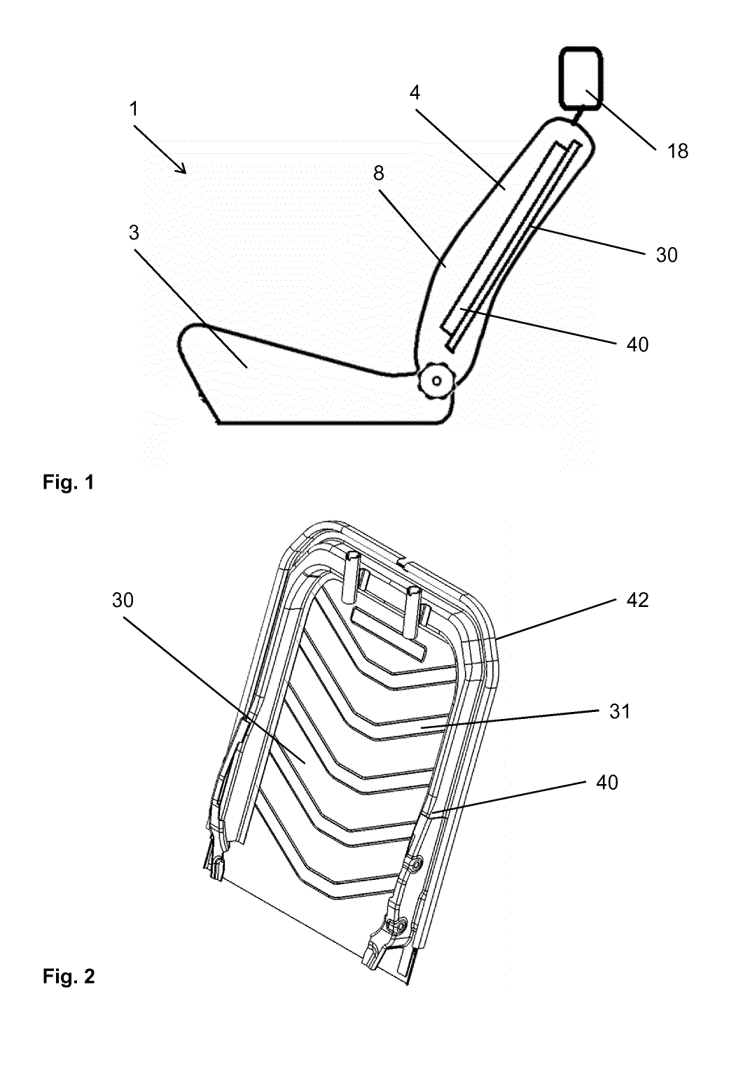

In the illustration according to FIG. 1, the backrest 4 is in the position for use thereof and consequently extends substantially in the vertical direction. The backrest 4 comprises a cushion 8 which rests at the front in the travel direction on the backrest structure, in particular the base sheet 30, and is covered with a cover which is not illustrated. At the upper end of the backrest 4 in the vertical direction, which end is facing away from the seat member 3, a headrest 18 which can be adjusted in terms of height and inclination is further arranged.

According to a first embodiment which is illustrated in FIG. 2, the backrest structure comprises a base sheet 30 and a partially peripheral backrest frame 40 which surrounds the base sheet 30 at three sides.

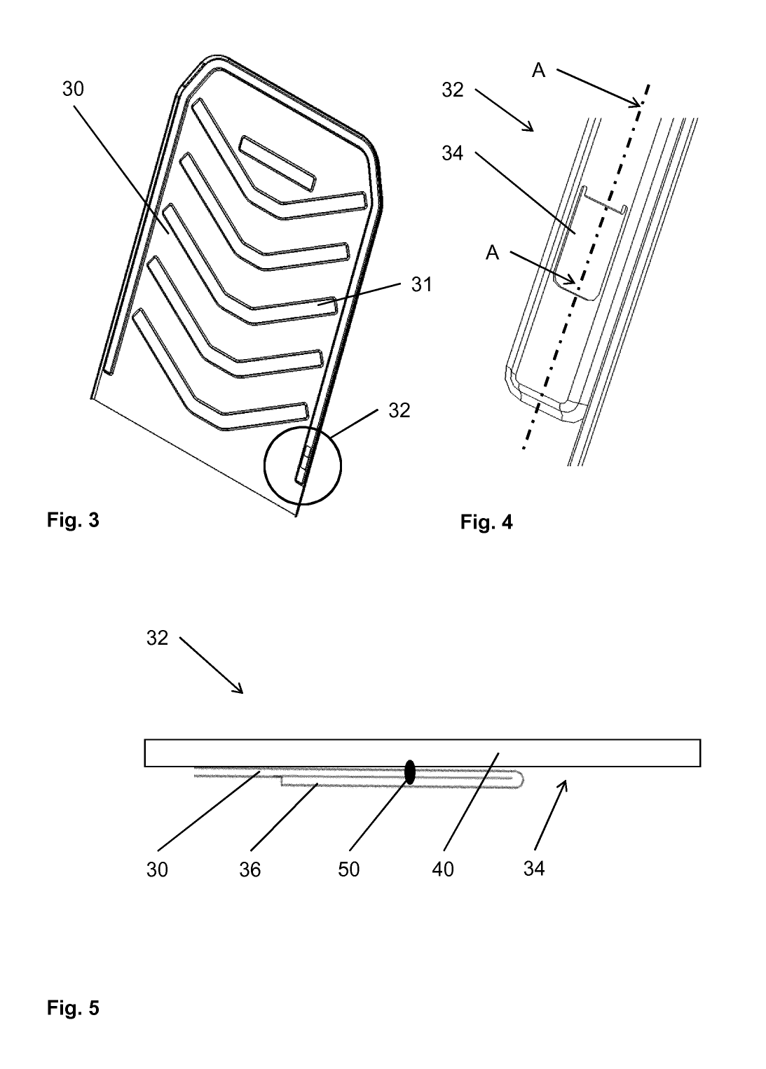

Close to the edge region thereof, the base sheet 30 has a plurality of securing locations 32, of which only one is shown in the simplified illustration of FIG. 3. Preferably, a plurality of securing locations 32 are arranged with defined spacings with respect to each other along the three sides on which the backrest frame 40 extends. The spacings may be equidistant.

In FIG. 4, one of the said securing locations 32 is illustrated to an enlarged scale. The securing location 32 comprises a substantially rectangular passage region 34. The passage region 34 is produced by means of a punching from the base sheet 30 with a U-shaped cross-section. In this instance, there is produced a tongue 36 which is separated from the remaining base sheet 30 at three sides and which is connected to the base sheet 30 at the fourth side thereof. The tongue 36 is then bent along the fourth side through approximately 180° and placed on the remaining base sheet 30. The base sheet 30 is thus folded once at the securing location 32, whereby the material thickness is doubled. The backrest frame 40 is then positioned and welded at the side of the base sheet 30 opposite the tongue 36.

The tongue 36 is rectangular in this instance but in modifications of the embodiment may, for example, also be of trapezoidal, semi-circular or polygonal form. The shape of the associated passage regions is then formed in accordance with the tongue shape.

The base sheet 30 is connected to the backrest frame 40 by means of laser welding. In this instance, the energy of the laser beam penetrates through the tongue 36 and the remaining base sheet 30 and is introduced into the backrest frame 40. In this instance, there is produced in the contact locations of the remaining base sheet 30 with the backrest frame 40 a weld seam 50 which extends, on the one hand, into the backrest frame 40 and, on the other hand, through the remaining base sheet 30 into the tongue 36.

Such a weld seam 50, which connects the base sheet 30 to the backrest frame 40 and extends over three material layers, is illustrated in FIG. 5.

In order to secure the cushion 8 to the backrest structure, the backrest frame 40 has an upholstery suspension channel 42. The upholstery suspension channel 42 surrounds the backrest frame 40 at three sides in this instance. The upholstery suspension channel 42 has, in the same manner as the remaining backrest frame 40, a material thickness of approximately 1.5 mm in this instance and is consequently constructed in a more rigid and secure manner than if it were a component of the relatively thin base sheet 30.

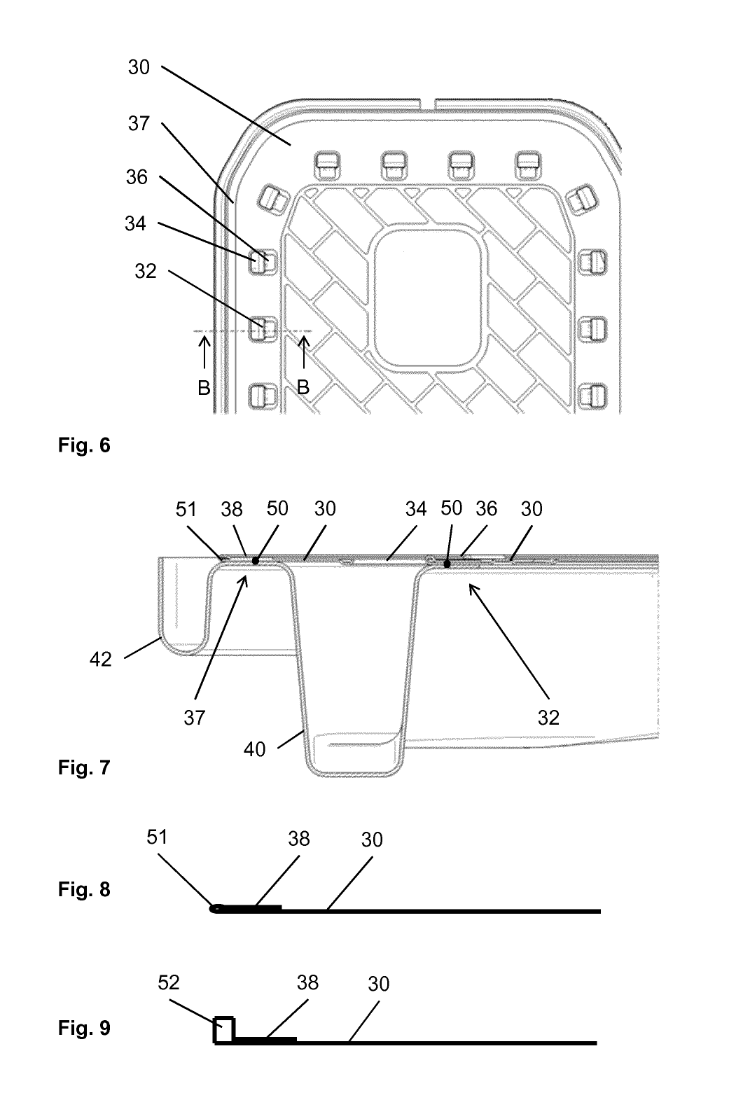

According to a second embodiment, which is illustrated in FIG. 6, the backrest structure also comprises a base sheet 30 and a partially peripheral backrest frame 40 which surrounds the base sheet 30 at three sides and which is welded to the base sheet 30.

The base sheet 30 has, similarly to in the first embodiment, a plurality of securing locations 32 with passage regions 34 and tongues 36. In a similar manner to in the first embodiment, the base sheet 30 is connected to the backrest frame 40 at securing locations 32 by means of weld seams 50 which each extend from the tongue 36 through the base sheet 30 into the backrest frame 40.

In addition, securing regions 37 are provided at the edge regions of the base sheet 30. At each securing region 37, edge material 38 which is located at the edge of the base sheet 30 and which is preferably constructed as tongues is bent through approximately 180° and placed on the remaining base sheet 30. A tongue of the base sheet 30 is therefore folded once at the securing region 37, whereby the material thickness is doubled. The backrest frame 40 is then positioned at the side of the base sheet 30 opposite the edge material 38.

The base sheet 30 is also connected to the backrest frame 40 at the securing regions 37, in a similar manner to at the securing locations 32, by means of weld seams 50 which each extend from the edge material 38 through the base sheet 30 into the backrest frame 40. FIG. 7 is a section through the backrest structure with a securing location 32 and a securing region 37.

According to a first configuration of the second embodiment, the tongue-like edge material 38, as illustrated in FIGS. 7 and 8, is simply bent through 180° and placed flat on the remaining base sheet 30. In this instance, simply a relatively flat first edge contour 51, which can be produced in a relatively simple manner.

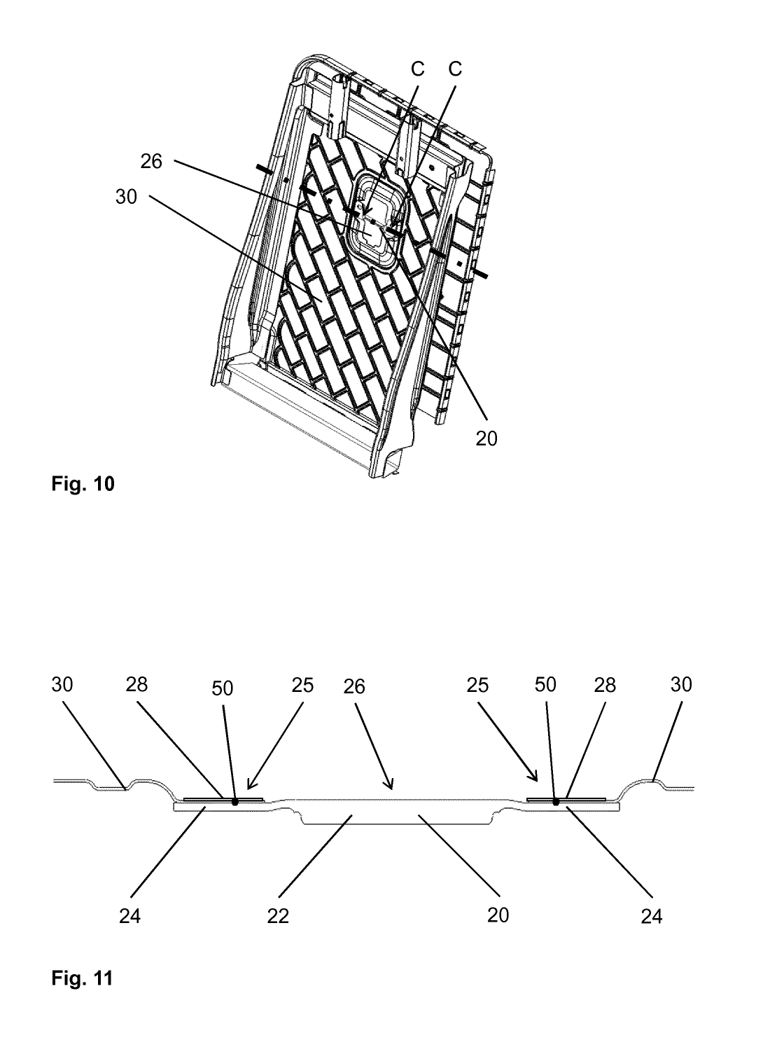

According to a second configuration of the second embodiment, the tongue-like edge material 38, as illustrated in FIG. 9, is bent several times and subsequently placed flat on the remaining base sheet 30. In this instance, the edge material 38 and the remaining base sheet 30 enclose a geometric shape, in this instance a rectangle. In this instance, there is produced, optionally partially, a contoured second edge contour 52 which increases the rigidity of the base sheet 30. Preferably, tongue-like edge material 38 is bent at a plurality of locations of each side of the base sheet 30.

Both edge contours 51, 52 afford the advantage that sharp-edged edge regions of the base sheet 30 are prevented. The risk of injury when the base sheets 30 are processed during the production of backrest frame structures is thereby reduced.

According to a third embodiment, which is illustrated in FIGS. 10 and 11, the backrest structure comprises a base sheet 30 to which a Top Tether clip 20 is secured. In this instance, the Top Tether clip 20 comprises a central portion 22 which has a substantially circular-cylindrical cross-section. At both sides of the central portion 22, a securing portion 24 which is constructed in a planar manner is provided.

The Top Tether clip 20 is produced from a rigid, round wire, wherein the securing portions 24 are produced by means of corresponding pressing or rolling of the wire. The Top Tether clip 20 engages over an opening 26 in the base sheet 30. In this instance, the securing portions 24 are located on a contact region 25 of the base sheet 30 and the central portion 22 bridges the opening 26.

The contact regions 25 of the base sheet 30 are produced, in a similar manner to the securing locations 32 and the securing regions 37, by tongues 28 which are constructed as flaps being bent through approximately 180°, wherein the tongues 28 are placed on the remaining base sheet 30. The base sheet 30 is therefore also folded once at the contact regions 25, whereby the material thickness is doubled. The securing portions 24 of the Top Tether clip 20 are then placed on the side of the base sheet 30 opposite the tongues 28.

The base sheet 30 is consequently connected to the Top Tether clip 20 at the contact regions 25, in a similar manner to at the securing locations 32 described or the securing regions 37, by means of weld seams 50 which each extend from the tongue 28 through the base sheet 30 into the securing portion 24 of the Top Tether clip 20. FIG. 11 is a section through the backrest structure with a Top Tether clip 20.

The features disclosed in the above description, the claims and the drawings may be significant both individually and in combination for the implementation of the invention in the various embodiments thereof.

While specific embodiments of the invention have been shown and described in detail to illustrate the application of the principles of the invention, it will be understood that the invention may be embodied otherwise without departing from such principles.

1. A backrest structure for a vehicle seat, the backrest structure comprising:
a planar base sheet;
an additional structural component comprising a backrest frame; and
at least one laser weld seam, the planar base sheet and the additional structural component being connected to each other by the at least one laser weld seam wherein in a region of the at least one laser weld seam at least one tongue of the base sheet is bent through 180° and placed on a remaining portion of the base sheet, and the at least one laser weld seam connects the bent tongue, the remaining portion of the base sheet and the additional structural component to each other.

2. The backrest structure as claimed in claim 1, wherein the base sheet has a material thickness of less than 0.5 mm.

3. (canceled)

4. The backrest structure as claimed in claim 1, wherein the base sheet has at least another tongue to provide a plurality of bent tongues arranged along an outer contour of the base sheet.

5. The backrest structure as claimed in claim 1, wherein the base sheet has at least one securing location which is spaced apart from the outer contour thereof.

6. The backrest structure as claimed in claim 5, wherein the securing location comprises a passage region and the at least one tongue.

7. The backrest structure as claimed in claim 1, wherein the bent tongue is a rectangular tongue which is separated at three sides from the remaining portion of the base sheet and which is bent through 180° at the fourth side which is connected to the remaining portion of the base sheet and placed on the remaining portion of the base sheet.

8. The backrest structure as claimed in claim 1, wherein bent tongue comprises edge material which is located at an edge of the base sheet.

9. The backrest structure as claimed in claim 8, wherein the edge material in the region of the at least one tongue is simply bent through 180°, whereby a flat edge contour is produced.

10. The backrest structure as claimed in claim 8, wherein the edge material is bent several times, wherein the edge material and the remaining portion of the base sheet enclose a geometric shape, whereby a contoured edge contour is produced.

11. The backrest structure as claimed in claim 3, wherein the backrest frame has an upholstery suspension channel for securing a cushion.

12. (canceled)

13. The backrest structure as claimed in claim 1, wherein the base sheet has at least one reinforcement bead.

14. The backrest structure as claimed in claim 1, wherein the base sheet is produced from sheet steel or sheet aluminum.

15. A vehicle seat comprising at least one backrest structure the backrest structure comprising:
a planar base sheet;
an additional structural component; and
at least one laser weld seam, the planar base sheet and the additional structural component being connected to each other by the at least one laser weld seam wherein in a region of the at least one laser weld seam at least one tongue of the base sheet is bent through 180° and placed on a remaining portion of the base sheet, and the at least one laser weld seam connects the bent tongue, the remaining portion of the base sheet and the additional structural component to each other.

16. The vehicle seat as claimed in claim 15, wherein the additional structural component is a backrest frame.

17. The vehicle seat as claimed in claim 15, wherein the base sheet has at least another tongue to provide a plurality of bent tongues arranged along an outer contour of the base sheet.

18. The vehicle seat as claimed in claim 15,wherein the base sheet has at least one securing location which is spaced apart from the outer contour thereof.

19. The vehicle seat as claimed in claim 15, wherein the securing location comprises a passage region and the at least one tongue.

20. The backrest structure as claimed in claim 15, wherein the bent tongue is a rectangular tongue which is separated at three sides from the remaining portion of the base sheet and which is bent through 180° at the fourth side which is connected to the remaining portion of the base sheet and placed on the remaining portion of the base sheet.

21. The backrest structure as claimed in claim 15, wherein the bent tongue comprises edge material which is located at an edge of the base sheet.

22. The backrest structure as claimed in claim 1, wherein the base sheet has a material thickness of between 0.3 mm and 0.5 mm.
